(19) United States
(12) Patent Application Publication
(10) Pub. No.: US 2020/0047186 A1
(43) Pub. Date: Feb. 13, 2020

(54) BI-METALLIC SWING HAMMERS

(71) Applicant: Babcock Power Services Inc., Marlborough, MA (US)

(72) Inventor: Qingsheng Lin, Holden, MA (US)

(21) Appl. No.: 16/100,692

(22) Filed: Aug. 10, 2018

(51) Int. Cl. B02C 13/28

(52) U.S. Cl. CPC B02C 13/28; B02C 2210/02

(57) ABSTRACT

A bi-metallic swing hammer for a particulate size reduction system includes a shank portion. The shank portion has a first end having a mounting portion for attachment to a wheel assembly of the particulate size reduction system, a second end defining a shank tip, and a face surface extending from the first end to the shank tip. The bi-metallic swing hammer includes a wear pad cast to the face surface of the shank portion. The wear pad extends from the shank tip to the first end of the shank portion up to the mounting portion. A method of constructing a bi-metallic swing hammer for a particulate size reduction system includes casting a wear pad and a shank portion together to bond the wear pad to the shank portion.

### BACKGROUND OF THE INVENTION

### 1. Field of the Invention

The present invention relates to methods and systems for material treatment, such as particulate size reduction. Particularly, the present invention is directed to methods and systems for material size reduction that are useful in coal technology.

### 2. Description of Related Art

In operations that use coal for fuel, finely-ground coal particles or “fines” are required for efficient operation, yielding higher combustion efficiency than stoker firing, as well as rapid response to load changes. Using coal fines for combustion has the potential for less nitrous oxide (NOₓ) emissions and keeps oversized loss-on-ignition (LOI) unburned coal particles from contaminating the marketable ash byproduct of the combustion chamber. Thus, it is common practice to supply raw coal to a device, such as a pulverizer, that will reduce the size of the coal to particles within a desirable size range prior to being conveyed to the furnace for combustion.

Many pulverizers employ systems and methods including one or more crushing and grinding stages for breaking up the raw coal. These crushing and grinding stages can sometimes include one or more swing hammers for breaking up the coal. Raw coal sizes are reduced by the repeated crushing and/or pulverizing action of rolling or impacting elements to dust fine enough to become airborne in an air stream swept through the pulverizer. The dust particles are entrained in the air stream and carried out for combustion. The process of reducing solid coal to acceptably sized fines requires equipment, particularly for impacting or grinding elements, of high strength and durability. For swing hammers, the important impacting elements are in the crusher section of the pulverizer, there is typically a hammer pad or crown (pulverizing surface) and the hammer shank (base material). The hardened hammer pad is typically formed separately from the hammer shank and then brazed together as a final product. The brazing process requires a high temperature that may cause softening of the pad material, similar to a heat treatment or tempering process, and thus may act to lower the wear resistance of the hammer pad. Moreover, the brazing process itself can be complex and time consuming in order to ensure suitable bond strength between the hammer pad and the shank.

The conventional techniques have been considered satisfactory for their intended purpose. However, there is an ever present need for crushing and grinding components which have increased wear life and improved strength. This disclosure provides a solution for this need.

### SUMMARY OF THE INVENTION

A bi-metallic swing hammer for a particulate size reduction system includes a shank portion. The shank portion has a first end having a mounting portion for attachment to a wheel assembly of the particulate size reduction system, a second end defining a shank tip, and a face surface extending from the first end to the shank tip. The bi-metallic swing hammer includes a wear pad cast to the face surface of the shank portion. The wear pad extends from the shank tip to the first end of the shank portion up to the mounting portion.

In accordance with some embodiments, the wear pad comprises cast iron, white iron, alloy steel with wear resistant performance, and/or alloy steel with corrosion resistant performance. The shank portion can include carbon steel and/or high strength alloy steel. The wear pad can define a longitudinal axis. The swing hammer can define a longitudinal axis. The mounting portion can include at least one aperture defined in a direction transverse to the longitudinal axis of the wear pad. A plane defined perpendicular to the longitudinal axis of the wear pad and/or the longitudinal axis of the wear pad can extend through the aperture and the wear pad. A plane defined parallel to the longitudinal axis of the swing hammer can bisect the aperture and intersect the wear pad.

In accordance with some embodiments, the wear pad is symmetrical with respect to central plane defined along the longitudinal axis between a front side of the wear pad and a mounting surface of the wear pad. The wear pad can be asymmetrical with respect to a plane defined along the longitudinal axis between first and second side surfaces of the wear pad.

In accordance with some embodiments, the bi-metallic swing hammer includes a metallurgical bond between the face surface of the shank and the mounting surface of the wear pad. The metallurgical bond can be configured and adapted to withstand shear stress ranging from 40 tons to 160 tons.

In accordance with another aspect, a method of constructing a bi-metallic swing hammer for a particulate size reduction system includes casting a wear pad and a shank portion together to bond the wear pad to the shank portion. The shank portion includes a first end having a mounting portion for attachment to a wheel assembly of the particulate size reduction system, a second end defining a shank tip, and a face surface extending from the first end to the shank tip. The wear pad extends from the shank tip to the first end of the shank portion up to the mounting portion.

It is contemplated that the wear pad can include cast iron, white iron, alloy steel with wear resistant performance, and/or alloy steel with corrosion resistant performance. The shank portion can include carbon steel and/or high strength alloy steel. The wear pad can define a longitudinal axis. The mounting portion includes at least one aperture defined in a direction transverse to the longitudinal axis of the wear pad. A plane defined perpendicular to the longitudinal axis can extend through the aperture and the wear pad. The wear pad can be symmetrical with respect to central plane defined along the longitudinal axis between a front side of the wear pad and a mounting surface of the wear pad. In accordance with some embodiments, the wear pad can be asymmetrical with respect to a plane defined along the longitudinal axis between first and second side surfaces of the wear pad. The method includes forming a metallurgical bond between the face surface of the shank and a mounting surface of the wear pad. The metallurgical bond can be configured and adapted to withstand shear stress ranging from 40 tons to 160 tons.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a side view of an exemplary embodiment of a bi-metallic swing hammer constructed in accordance with the present disclosure, showing the shank portion and the wear pad;

FIG. 2 is a front view the bi-metallic swing hammer of FIG. 1, showing the front side of the wear pad;

FIG. 3 is a micrograph of a portion of the bi-metallic swing hammer of FIG. 1, showing the bond between the wear pad and the shank portion;

FIG. 4 is a perspective view of the bi-metallic swing hammer of FIG. 1, showing a front side of the wear pad;

FIG. 5 is a back perspective view of the bi-metallic swing hammer of FIG. 1, showing a back surface of the shank portion and a plane G;

FIG. 6 is a side view of a cross-section of the bi-metallic swing hammer of FIG. 1, showing a seam between the face surface of the shank portion and the mounting surface of the wear pad;

FIG. 7 is side view of another exemplary embodiment of a bi-metallic swing hammer constructed in accordance with the present disclosure, showing the shank portion and the wear pad;

FIG. 8 is a back perspective view the bi-metallic swing hammer of FIG. 7, showing the back side of the shank portion; and

FIG. 9 is a side view of a cross-section of the bi-metallic swing hammer of FIG. 7, showing a seam between the face surface of the shank portion and the mounting surface of the wear pad.

### DETAILED DESCRIPTION OF THE PREFERRED EMBODIMENTS

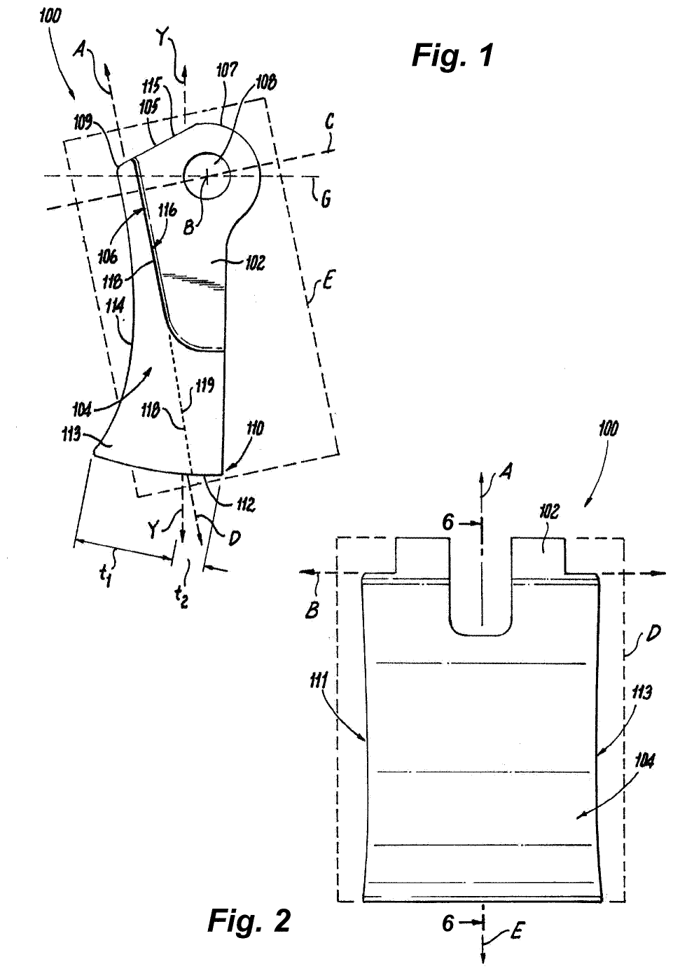

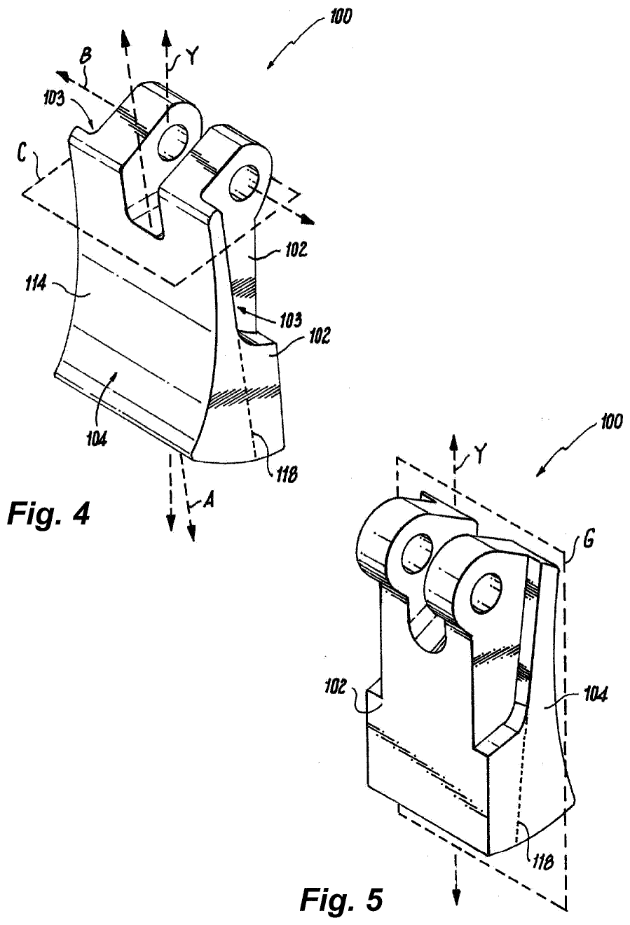

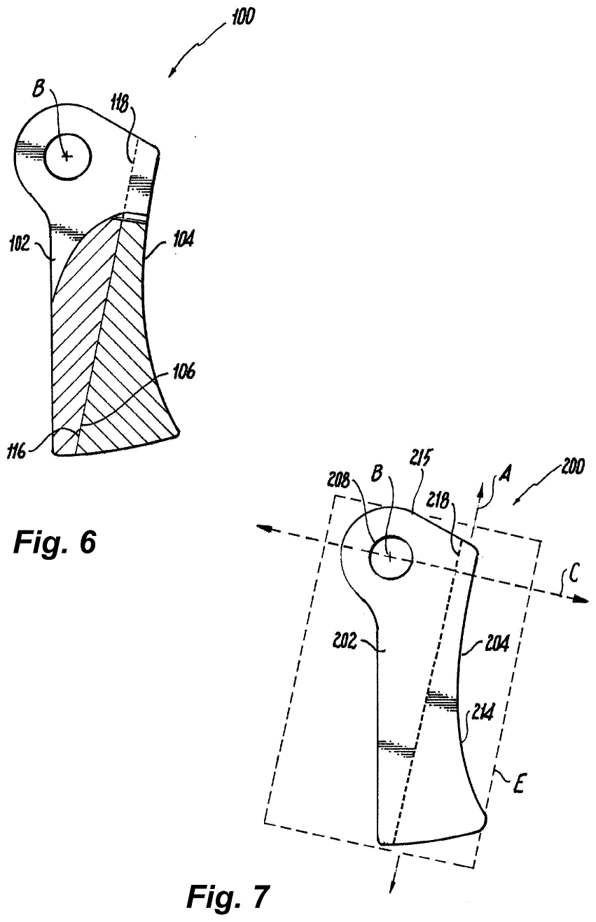

Reference will now be made to the drawings wherein like reference numerals identify similar structural features or aspects of the subject disclosure. For purposes of explanation and illustration, and not limitation, a partial view of an exemplary embodiment of a bi-metallic swing hammer in accordance with the disclosure is shown in FIG. 1 and is designated generally by reference character 100. Other embodiments of swing-hammers in accordance with the disclosure, or aspects thereof, are provided in FIGS. 2-9, as will be described. The apparatuses and methods described herein resolve issues that can result from brazing portions of the swing hammer together. Specifically, embodiments of the present invention use a bi-metallic casting process to cast both the hammer/wear pad and shank of the swing hammer in a single process without the need for brazing.

As shown in FIG. 1, a bi-metallic swing hammer 100 for a particulate size reduction system includes a shank portion 102. The shank portion 102 has a first end 105 having a mounting portion 107 for attachment to a wheel assembly of the particulate size reduction system. Shank portion 102 includes a second end 110 defining a shank tip 112. Shank portion 102 includes a face surface 106 extending from first end 105 to shank tip 112. Bi-metallic swing hammer 100 includes a wear pad 104 cast to face surface 106 of shank portion 102. Wear pad 104 extends from shank tip 112 to first end 105 of shank portion 102 up to mounting portion 107, e.g. when viewed from the side (FIG. 1), wear pad 104 includes a surface 109 that is flush with a surface 115 at first end 105 of the shank between the wear pad 104 and mounting portion 107. Because shank portion 102 and wear pad 104 of hammer 100 are cast together, wear pad 104 can be made from a wear resistant material while its base material is made with ductile material. This is particularly useful in the case of swing hammer 100 as it tends to provide both high mechanical strength and wear resistance. In embodiments of the present invention, wear pad 104 is made from cast iron, white iron, alloy steel with wear resistant performance, and/or alloy steel with corrosion resistant performance to enhance hardness and wear resistance and shank portion 102 is made from carbon steel and/or high strength alloy steel to satisfy mechanical strength.

As shown in FIGS. 1-2 and 5, wear pad 104 defines a longitudinal axis A and hammer 100 (e.g. the wear pad 104 and shank 102 combined) defines a longitudinal axis Y. Mounting portion 107 includes apertures 108 defining an aperture axis B in a direction transverse to longitudinal axis A of wear pad 104. Wear pad 104 extends over the entire face surface 106 of shank portion 102 such that a plane C defined perpendicular to longitudinal axis A extends through the apertures 108 and wear pad 104. A plane G defined perpendicular to longitudinal axis Y also extends through the apertures 108 and wear pad 104. This assists in reducing erosion and/or abrasion of shank portion 102. More specifically, in embodiments of the present invention, shank tip 112, in the longitudinal direction relative to shank portion 102, is entirely covered such that a plane F extending between first and second side surfaces 111 and 113, respectively, defined parallel to longitudinal axis Y that bisects the aperture also intersects wear pad 104. Wear pad 104 covers all shank area subject to erosion and/or abrasion, as shown in FIG. 1. This assists in reducing erosion and/or abrasion of shank portion 102. Moreover, there is additional wear resistant material of wear pad 104 near the shank tip 102 to extend wear life. In accordance with some embodiments the thickness t₁ of wear pad 104 is more than twice thickness t₂ of shank portion 102 at shank tip, e.g. a wear pad thickness ratio of 2:1 or greater.

As shown in FIGS. 1-2, 4 and 6, wear pad 104 is asymmetrical with respect to a plane D defined along longitudinal axis A between first and second side surfaces 111 and 113, respectively, of wear pad 104. Wear pad 104 is symmetrical with respect to central plane E defined along longitudinal axis A between a front side 114 of wear pad 104 and a mounting surface 116 of wear pad 104.

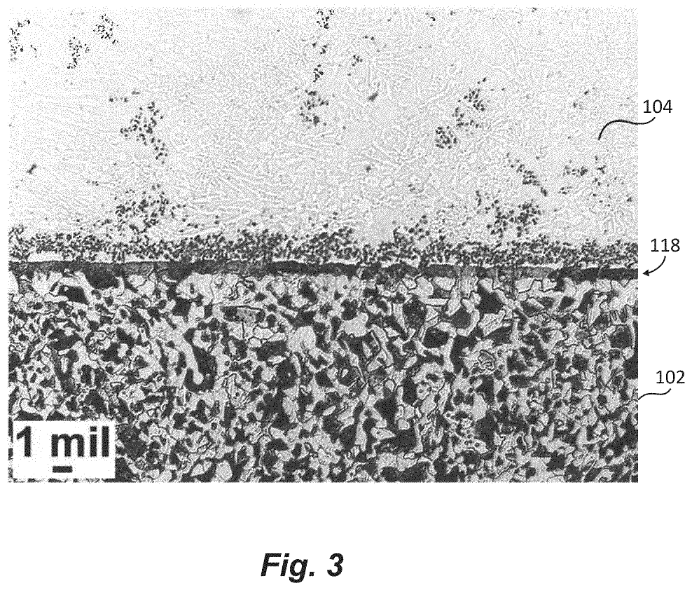

As shown in FIGS. 1 and 3, swing hammer 100 includes a metallurgical bond at a seam 118 between face surface 106 of shank and mounting surface 116 of wear pad 104. The metallurgical bond is configured and adapted to withstand shear stress that is sufficient to prevent wear pad 104 from separating with shank 102 during the hammer operation. In accordance with some embodiments, the metallurgical bond at a cut section proximate to plane E for seam 118 is configured to withstand shear testing where the shear stress ranges from 40 tons to 160 tons. Seam 118 between face surface 106 of shank and mounting surface 116 of wear pad 104 extends from first end 105 of shank portion 102 to tip 112 of shank portion 102.

As shown in FIGS. 7-9, in some embodiments, instead of shank portion 102 having recessed portions 103 on each side shank portion 102, a bi-metallic swing hammer 200 for a particulate size reduction system includes side surfaces 211 and 213 that are defined in the same plane, e.g. there is no recess 103. Swing hammer 200 without the recessed sides provides more material for both sides of the hammer and is typically used for applications where the hammer 200 is subject to severe side wear. Swing hammer 100 provides a lighter alternative to swing hammer 200, thus reducing material and costs. Other than the absence of the recess in the shank portion 202, swing hammer 200 is largely the same as swing hammer 100. Swing hammer 200 includes a shank portion 202. The shank portion 202 has a first end 205 having a mounting portion 207 similar to shank 102, first end 105 and mounting portion 107. Shank portion 202 includes a second end 210 defining a shank tip 212. Shank portion 202 includes a face surface 206 extending from first end 205 to shank tip 212. Bi-metallic swing hammer 200 includes a wear pad 204 cast to face surface 206 of shank portion 202. Wear pad 204 extends from shank tip 212 to first end 205 of shank portion 202 up to mounting portion 207, e.g. when viewed from the side (FIG. 7), wear pad 204 includes a surface 209 that is flush with a surface 215 at first end 205 of the shank between the wear pad 204 and mounting portion 207. Because shank portion 202 and wear pad 204 of hammer 200 are cast together, wear pad 204 can be made from a wear resistant material as described above with respect to wear pad 104. Shank portion 202 is also made from similar materials as described above with respect to shank portion 102.

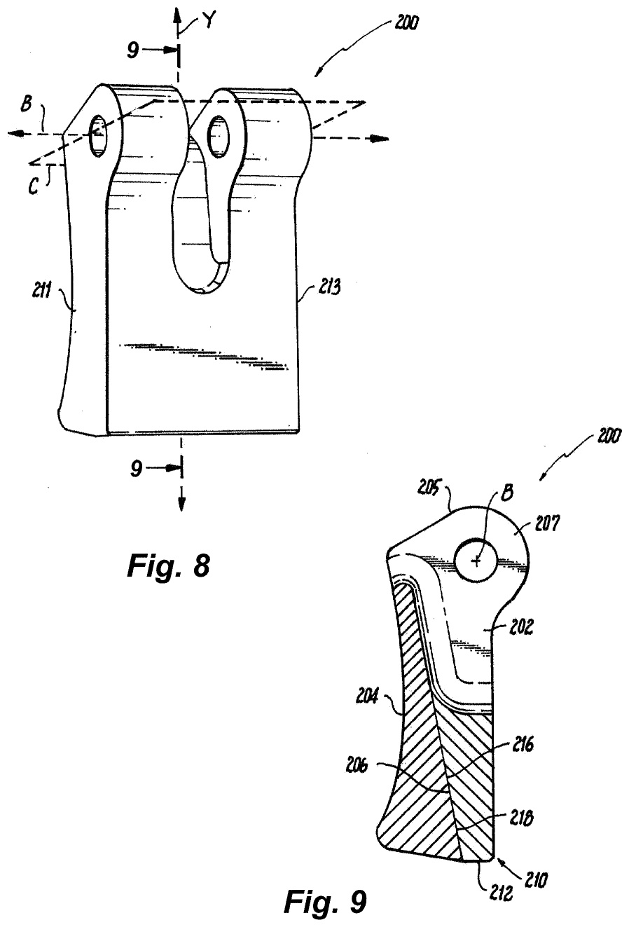

As shown in FIGS. 7-8, wear pad 204 defines a longitudinal axis A and hammer 200 (e.g. the wear pad 204 and shank 202 combined) defines a longitudinal axis Y. Mounting portion 207 includes apertures 208 defining an aperture axis B in a direction transverse to longitudinal axis A of wear pad 204. Wear pad 204 extends over the entire face surface 206 of shank portion 202 such that a plane C defined perpendicular to longitudinal axis A extends through the apertures 208 and wear pad 204. A plane G defined perpendicular to longitudinal axis Y also extends through the apertures 208 and wear pad 204. This assists in reducing erosion and/or abrasion of shank portion 202. Shank tip 212, in the longitudinal direction relative to shank portion 202, is entirely covered such that a plane F extending between first and second side surfaces 211 and 213, respectively, of wear pad 204, defined parallel to longitudinal axis Y that bisects the aperture also intersects wear pad 204. Wear pad 204 is substantially the same as wear pad 104 described above. Similar to wear pad 104, thickness t₁ of wear pad 204 is more than twice thickness t₂ of shank portion 202 at shank tip, e.g. a wear pad thickness ratio of 2:1 or greater. Wear pad 204 is asymmetrical with respect to a plane D defined along longitudinal axis A between first and second side surfaces 211 and 213, respectively. Wear pad 204 is symmetrical with respect to central plane E defined along longitudinal axis A between a front side 214 of wear pad 204 and a mounting surface 216 of wear pad 204.

As shown in FIGS. 7 and 9, swing hammer 200 includes a metallurgical bond at a seam 218 between face surface 206 of shank and mounting surface 216 of wear pad 204. The metallurgical bond 218 is similar to metallurgical bond 118 described above and is configured and adapted to withstand the same shear stresses as described above.

A method of constructing a bi-metallic swing hammer, e.g. bi-metallic swing hammer 100 or 200, for a particulate size reduction system includes casting a wear/hammer pad, e.g. wear pad 104 or 204, and a shank portion, e.g. shank portion 102 or 202, together in a single process, to bond the wear pad to the shank portion. A micrograph depicting the bond between the wear pad and shank portion is shown in FIG. 3. The method includes using a common model to cast the shank portion first and the wear pad (in the same model). The method includes forming a metallurgical bond, shown by seams 118/218, between the face surface of the shank and a mounting surface, e.g. mounting surface 116 or 216, of the wear pad. By casting the shank portion and the wear pad together, the traditional brazing process can be eliminated as metallurgical bonding is achieved through the bi-metallic casting process.

The methods and systems of the present disclosure, as described above and shown in the drawings, provide for swing hammers with superior properties relative to traditional swing hammers including reduced manufacturing time, longer life and improved robustness. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A bi-metallic swing hammer for a particulate size reduction system, comprising:
a) a shank portion having:
i) a first end having a mounting portion for attachment to a wheel assembly of the particulate size reduction system;
ii) a second end defining a shank tip; and
iii) a face surface extending from the first end to the shank tip; and
b) a wear pad cast to the face surface of the shank portion, the wear pad extending from the shank tip to the first end of the shank portion up to the mounting portion.

2. The swing hammer of claim 1, wherein the wear pad comprises at least one of cast iron, white iron, alloy steel with wear resistant performance, or alloy steel with corrosion resistant performance.

3. The swing hammer of claim 1, wherein the shank portion comprises at least one of carbon steel or high strength alloy steel.

4. The swing hammer of claim 1, wherein the wear pad defines a longitudinal axis, and wherein the mounting portion includes at least one aperture defined in a direction transverse to the longitudinal axis of the wear pad.

5. The swing hammer of claim 4, wherein a plane defined perpendicular to the longitudinal axis extends through the aperture and the wear pad.

6. The swing hammer of claim 4, wherein the swing hammer defines a longitudinal axis, wherein a plane defined perpendicular to at least one of the longitudinal axis of the wear pad or the longitudinal axis of the swing hammer extends through the aperture and the wear pad, and wherein a plane defined parallel to the longitudinal axis of the swing hammer bisects the aperture and intersects the wear pad.

7. The swing hammer of claim 1, wherein the swing hammer defines a longitudinal axis, wherein a plane defined parallel to the longitudinal axis of the swing hammer bisects the aperture and intersects the wear pad.

8. The swing hammer of claim 1, wherein the wear pad defines a longitudinal axis, wherein the wear pad is symmetrical with respect to central plane defined along the longitudinal axis between a front side of the wear pad and a mounting surface of the wear pad.

9. The swing hammer of claim 1, wherein the wear pad defines a longitudinal axis, wherein the wear pad is asymmetrical with respect to a plane defined along the longitudinal axis between first and second side surfaces of the wear pad.

10. The swing hammer of claim 1, further comprising a metallurgical bond between the face surface of the shank and a mounting surface of the wear pad, wherein the metallurgical bond is configured and adapted to withstand shear stress ranging from 40 tons to 160 tons.

11. A method of constructing a bi-metallic swing hammer for a particulate size reduction system:
casting a wear pad and a shank portion together to bond the wear pad to the shank portion, wherein the shank portion includes:
i) a first end having a mounting portion for attachment to a wheel assembly of the particulate size reduction system;
ii) a second end defining a shank tip; and
iii) a face surface extending from the first end to the shank tip;
and wherein the wear pad extends from the shank tip to the first end of the shank portion up to the mounting portion.

12. The method of claim 11, wherein the wear pad comprises at least one of cast iron, white iron, alloy steel with wear resistant performance, or alloy steel with corrosion resistant performance.

13. The method of claim 11, wherein the shank portion comprises at least one of carbon steel or high strength alloy steel.

14. The method of claim 11, wherein the wear pad defines a longitudinal axis, and wherein the mounting portion includes at least one aperture defined in a direction transverse to the longitudinal axis of the wear pad.

15. The method of claim 11, wherein the wear pad defines a longitudinal axis, wherein a plane defined perpendicular to the longitudinal axis extends through the aperture and the wear pad.

16. The method of claim 11, wherein the wear pad defines a longitudinal axis, wherein the wear pad is symmetrical with respect to central plane defined along the longitudinal axis between a front side of the wear pad and a mounting surface of the wear pad.

17. The method of claim 11, wherein the wear pad defines a longitudinal axis, wherein the wear pad is asymmetrical with respect to a plane defined along the longitudinal axis between first and second side surfaces of the wear pad.

18. The method of claim 11, further comprising forming a metallurgical bond between the face surface of the shank and a mounting surface of the wear pad, wherein the metallurgical bond is configured and adapted to withstand shear stress ranging from 40 tons to 160 tons.
